(19) United States
(12) Patent Application Publication
(10) Pub. No.: US 2025/0294405 A1
(43) Pub. Date: Sep. 18, 2025

(54) WIRELESS TRANSMISSION DEVICE AND METHOD FOR INDICATING ASSOCIATION OF PROTOCOL DATA UNIT SET

(71) Applicant: LENOVO (BEIJING) LIMITED, Beijing (CN)

(72) Inventors: Xiaoying Xu, Shanghai (CN); Mingzeng Dai, Shanghai (CN); Jing Han, Beijing (CN); Lianhai Wu, Beijing (CN); Congchi Zhang, Shanghai (CN)

(21) Appl. No.: 18/860,157

(22) PCT Filed: Apr. 27, 2022
(86) PCT No.: PCT/CN2022/089564

§ 371 Date: Oct. 25, 2024

(51) Int. Cl. H04W 28/02; H04L 49/00

(52) U.S. Cl. CPC H04W 28/0278; H04L 49/3009

(57) ABSTRACT

The present application relates to a wireless transmission device and method for indicating association of PDU set. The wireless transmission device determines an indication of a PDU belonging to a PDU set. The indication is associated with the PDU set. The wireless transmission device transmit the indication to another wireless transmission device. The indication is included in at least one of: a layer 2 header of the PDU, a MAC CE associated with the PDU, a BSR MAC CE, and a layer header of the BSR MAC CE.

### TECHNICAL FIELD

Embodiments of the present application generally relate to wireless communication technology, especially to a wireless transmission device and method for indicating association of protocol data unit set.

### BACKGROUND

Extended Reality (XR), including Augmented Reality (AR) and Virtual Reality (VR), as well as Cloud Gaming (CG), presents a new promising category of connected devices, applications, and services. Application and traffic awareness in Radio Access Network (RAN) is one of key feature to improve user experience of XR services. Regarding XR services, a group of internet protocol (IP) packets is used to carry payloads of a protocol data unit (PDU) Set (e.g., a frame) and the size of the PDU set is variable. In application layer, if one PDU associated with a PDU set is lost, the whole PDU set may not be successfully decoded by the application layer.

However, when a packet delay budget (PDB) is larger than a PDU set arrival period, two adjacent PDU sets may arrive at a base station at the same period due to a HARQ retransmission caused for the former PDU set. Therefore, it is difficult for the base station to distinguish which media access control (MAC) service data units (SDUs) in transport blocks (TBs) belong to one PDU set so that the base station cannot determine how to increase the transmission reliability for the TBs to avoid the transmission delay of the TBs exceeding the PDB. Further, in some cases of TBs transmission failure, it is difficult for the base station to determine which PDU set fails transmission, which also impacts the optimization scheduling for a subsequent PDU set decoding.

### SUMMARY

Some embodiments of the present application provide a wireless transmission device. The wireless transmission device includes: a processor and a transceiver coupled to the processor. The processor is configured to: determine an indication of a protocol data unit (PDU) belonging to a PDU set, wherein the indication is associated with the PDU set; transmit, via the transceiver, the indication to another wireless transmission device, wherein the indication is included in at least one of: a layer 2 header of the PDU, a media access control (MAC) control element (CE) associated with the PDU, a buffer status report (BSR) MAC CE, and a layer 2 header of the BSR MAC CE.

Some embodiments of the present application provide a method of a wireless transmission device. The method includes: determining, by the wireless transmission device, an indication of a PDU belonging to a PDU set, wherein the indication is associated with the PDU set; transmitting, by the wireless transmission device, the indication to another wireless transmission device, wherein the indication is included in at least one of: a layer 2 header of the PDU, a MAC CE associated with the PDU, a BSR MAC CE, and a layer 2 header of the BSR MAC CE.

Some embodiments of the present application provide a wireless transmission device. The wireless transmission device includes: a processor and a transceiver coupled to the processor. The processor s configured to: receive, via the transceiver, an indication of a PDU belonging to a PDU set from another wireless transmission device, wherein the indication is associated with the PDU set, and is included in at least one of: a layer 2 header of the PDU, a MAC CE associated with the PDU, a BSR MAC CE, or a layer 2 header of the BSR MAC CE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 is a schematic diagram of message transmission in accordance with some embodiments of the present application.

FIG. 3 is a schematic diagram of a MAC sub-header in accordance with some embodiments of the present application.

FIG. 4 is a schematic diagram of an RLC header in accordance with some embodiments of the present application.

FIG. 5 is a schematic diagram of a PDCP header in accordance with some embodiments of the present application.

FIG. 6 is a schematic diagram of a SDAP header in accordance with some embodiments of the present application.

FIG. 7 is a schematic diagram of message transmission in accordance with some embodiments of the present application.

FIG. 8 is a schematic diagram of a PDCP header in accordance with some embodiments of the present application.

FIG. 9 which is a schematic diagram of an RLC header in accordance with some embodiments of the present application.

FIG. 10 is a schematic diagram of using a PDCP control PDU in accordance with some embodiments of the present application.

FIG. 11 is a schematic diagram of using a MAC CE in accordance with some embodiments of the present application.

FIG. 12 is a schematic diagram of an indication included in a MAC CE in accordance with some embodiments of the present application.

FIG. 13 is a schematic diagram of an indication included in a MAC CE in accordance with some embodiments of the present application.

FIG. 14 is a schematic diagram of a BSR MAC CE in accordance with some embodiments of the present application.

FIG. 15 is a schematic diagram of a BSR MAC CE in accordance with some embodiments of the present application.

FIG. 16 is a schematic diagram of a BSR MAC CE in accordance with some embodiments of the present application.

FIG. 17 is a schematic diagram of a BSR MAC CE in accordance with some embodiments of the present application.

FIG. 18 is a schematic diagram of a MAC sub-header in accordance with some embodiments of the present application.

FIGS. 19A to 19C illustrate flow charts of a method for wireless communications in accordance with some embodiments of the present application.

FIG. 20 illustrates a block diagram of a wireless transmission device in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

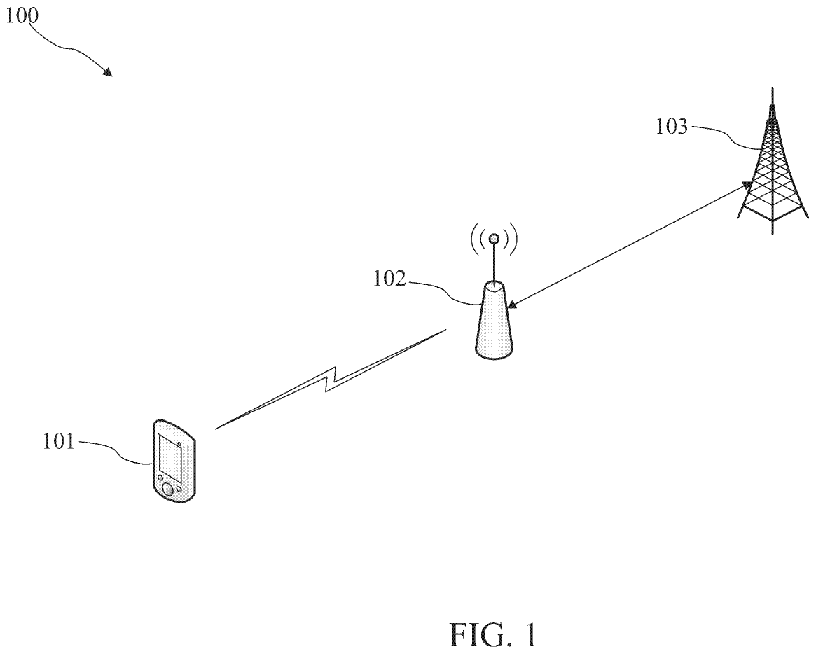

Referring to FIG. 1, a wireless communication system 100 may include a user equipment (UE) 101, a base station (BS) 102 and a core network (CN) 103. Although a specific number of the UE 101, the BS 102 and the CN 103 are depicted in FIG. 1, it is contemplated that any number of the UEs 101, the BSs 102 and the CNs 103 may be included in the wireless communication system 100.

The CN 103 may include a core Access and Mobility management Function (AMF) entity. The BS 102, which may communicate with the CN 103, may operate or work under the control of the AMF entity. The CN 103 may further include a User Plane Function (UPF) entity, which communicatively coupled with the AMF entity.

The BS 102 may be distributed over a geographic region. In certain embodiments of the present application, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally part of a radio access network that may include one or more controllers communicably coupled to one or more corresponding BS(s).

The UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, the UE 101 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, the UE 101 may include, for example, but is not limited to, wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101 may communicate directly with the BS 102 via uplink communication signals.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G New Radio (NR) of the 3GPP protocol or the 5G NR-light (or reduced capability NR UEs) of the 3GPP protocol, wherein the BS 102 transmits data using an OFDM modulation scheme on the downlink (DL) and the UE 101 transmits data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, the UE 101 and BS 102 may communicate using other communication protocols, such as the IEEE 802.11 family of wireless communication protocols. Further, in some embodiments of the present application, the UE 101 and BS 102 may communicate over licensed spectrums, whereas in other embodiments, the UE 101 and the BS 102 may communicate over unlicensed spectrums. The present application is not intended to be limited to the implementation of any particular wireless communication system architecture or protocol. In yet some embodiments of present application, the BS 102 may communicate with the UE 101 using the 3GPP 5G protocols.

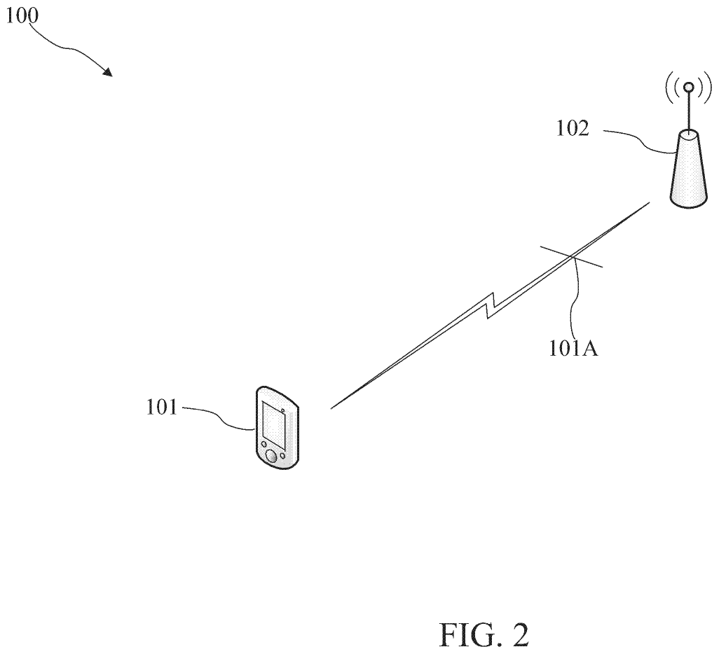

FIG. 2 is a schematic diagram of message transmission in accordance with some embodiments of the present application. In some embodiments, the UE 101 may determine a protocol data unit (PDU) arrives from an upper layer. The PDU may belong to an UL PDU set. Then, the UE 101 may determine an indication 101A of the PDU belonging to the UL PDU set. The indication 101A may be associated with the UL PDU set. More specifically, the indication 101A may be used to indicate which media access control (MAC) service data unit (SDU) belongs to the UL PDU set. In some embodiments, the UL PDU set may be a frame (e.g., a video frame) or a slice (e.g., a video slice) or an application data unit (ADU).

Then, the UE 101 may transmit the indication 101A to indicate the BS 102 which MAC SDU belongs to the UL PDU set so that the BS 102 may efficiently schedule transmission per UL PDU set, or may easily determine whether a PDU set is successfully received at MAC/radio link control (RLC)/packet data convergence protocol (PDCP) layer. The indication 101A may be included in: (1) a layer 2 header of the PDU; (2) a MAC control element (CE) associated with the PDU; or (3) a layer 2 header of a buffer status report (BSR) MAC CE.

In some embodiments, the indication 101A is included in the layer 2 header of the PDU. In particular, when the UE 101 determines that a PDU of a new PDU set or a PDU of another PDU set arrives from an upper layer of the UE 101, the UE 101 determines the indication 101A and includes the indication 101A in the layer 2 header of the PDU with a toggled value. In some cases, the indication may be determined periodically upon receiving a set of PDUs from the upper layer, or directly informed by the upper layer, or derived from the PDU set information received from the upper layer. The indication 101A is used to indicate the arrival of the PDU set. Then, the UE 101 transmits the indication 101A in the PDU to the BS 102. The layer 2 header of the PDU may be: (1) a MAC sub-header; (2) an RLC header; (3) a PDCP header; or (4) a service data adaptation protocol (SDAP) header.

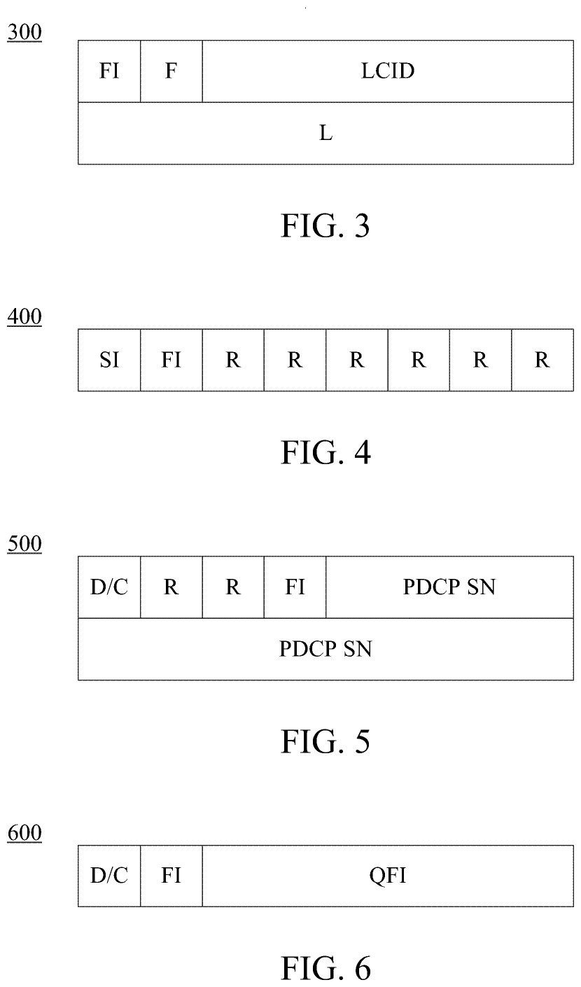

In some cases, the layer 2 header of the PDU may be the MAC sub-header. Specifically, refer to FIG. 3 which is a schematic diagram of the MAC sub-header 300 in accordance with some embodiments of the present application, the MAC sub-header 300 may include at least one field of: (1) “FI”; (2) “F”; (3) “LCID”; and (4) “L”. In detail, “FI” field may be the indication 101A. “F” field may be a value indicating the size of “L” field. “LCID” field may indicate logical channel identification. “L” filed may indicate length of corresponding MAC SDU or variable-sized MAC CE.

In some cases, the layer 2 header of the PDU may be the RLC header. Specifically, refer to FIG. 4 which is a schematic diagram of the RLC header 400 in accordance with some embodiments of the present application, the RLC header 400 may include at least one field of: (1) “SI”; (2) “FI”; and (3) “R”. In detail, “SI” field indicates whether an RLC PDU contains a complete RLC SDU or the first, middle, last segment of an RLC SDU. “FI” field may be the indication 101A. “R” field may be reserved bit(s).

In some cases, the layer 2 header of the PDU may be the PDCP header. Specifically, refer to FIG. 5 which is a schematic diagram of the PDCP header 500 in accordance with some embodiments of the present application, the PDCP header 500 may include at least one field of: (1) “D/C”; (2) “R”; (3) “FI”; and (4) “PDCP SN”. In detail, “D/C” field may indicate type of data PDU or control PDU. “R” field may be reserved bit(s). “FI” field may be the indication 101A. “PDCP SN” field may be the sequence of the corresponding PDCP.

In some cases, the layer 2 header of the PDU may be the SDAP header. Specifically, refer to FIG. 6 which is a schematic diagram of the SDAP header 600 in accordance with some embodiments of the present application, the SDAP header 600 may include fields of: (1) “D/C”; (2) “FI”; and (3) “QFI”. In detail, “D/C” field may indicate type of data PDU or control PDU. “FI” field may be the indication 101A. “QFI” field may be the QoS flow identifier.

In some embodiments, “FI” field may be 1 bit. The “FI” field with toggle value is used to differentiate a PDU set between two adjacent PDU sets. From point view of reception side, comparing to a value of “FI” of previously received, the PDU set of the PDU associated with the “FI” may be considered as a new or another PDU set when the value of ‘FI’ is toggled. For example, if the “FI” field is present in the PDPC header, the receiving PDCP entity can differentiate a PDU set based on the “FI” field value and the PDCP COUNT of the PDU after the PDCP reordering operation. For example, comparing to value 0 of “FI” of the previously received, the PDU set of the PDU associated with the “FI” is considered as a new or another PDU set when the value of ‘FI’ is toggled as 1; comparing to value 1 of “FI” of the previously received, the PDU set of the PDU associated with the “FI” is considered as a new or another PDU set when the value of ‘FI’ is toggled as 0. For example, the value of the “FI” of the first PDU set can be 1, value of the “FI” of the second PDU et can be 0, value of the “FI” of the third PDU set can be 1, value of the “FI” of the fourth PDU set can be 0. For example, the value of the “FI” of the first PDU set can be 0 and versa.

In some embodiments “FI” field may be 1 bit. The “FI” field with toggle value is used to differentiate a PDU set between two adjacent PDU sets. From point view of transmission side, comparing to a value of “FI” of the previous transmission, the “FI” indicates the PDU set of the associated PDU as a new or another PDU set when the value of ‘FI’ is toggled. For example, comparing to value 0 of “FI” of the previous transmission, the “FI” indicates the PDU set of the associated PDU as a new or another PDU set when the value of ‘FI’ is toggled as 1; comparing to value 1 of “FI” of the previous transmission, the “FI” indicates the PDU set of the associated PDU as a new or another PDU set when the value of ‘FI’ is toggled as 0. For example, the value of the “FI” of the first PDU set can be 1, value of the “FI” of the second PDU et can be 0, value of the “FI” of the third PDU set can be 1, value of the “FI” of the fourth PDU set can be 0. For example, if the value of the “FI” of the first PDU set can be 0 then and versa.

In some embodiments, a function of “FI” field of the layer 2 header may be enabled per logical channel (LCH), per data radio bearer (DRB) or per QoS flow identifier (QFI) by the BS 102. For example, the BS 102 transmits a configuration to the UE 101 to enable the function of “FI” field. When a specific LCH is configured to enable the function of “FI” field by the BS 102, the UE 101 set the toggled value of “FI” field of the layer 2 header corresponding to MAC SDU(s) of the specific LCH. When a specific DRB is configured to enable the function of “FI” field by the BS 102, the UE 101 set the toggled value of “FI” field of the layer 2 header: (1) corresponding to the MAC SDU(s) of a LCH of the specific DRB; or (2) corresponding to PDCP SDU(s) of the specific DRB. When a specific QFI is configured to enable function of “FI” field by the BS102, the UE 101 set the toggled value of “FI” field of the layer 2 header corresponding to SDAP SDU(s) of the specific QFI.

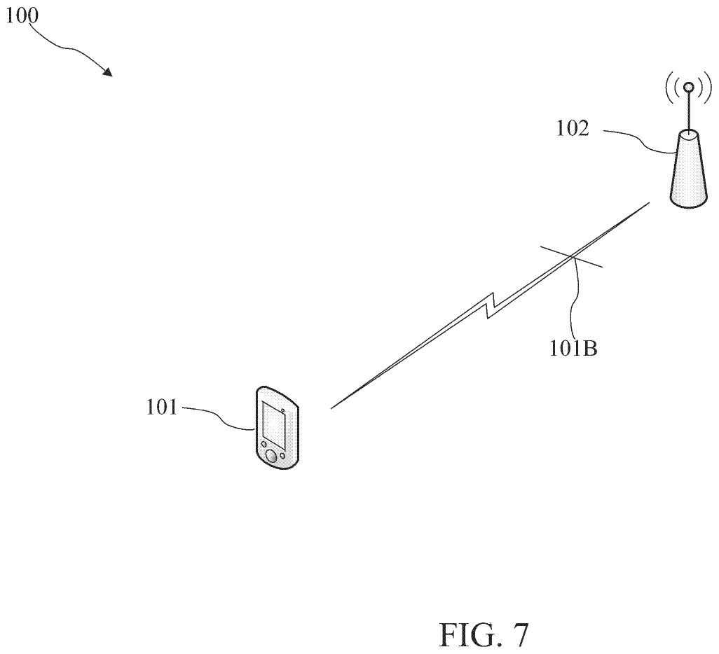

FIG. 7 is a schematic diagram of message transmission in accordance with some embodiments of the present application. In some embodiments, when the indication 101A is included in: (1) the layer 2 header of the PDU; or (2) the MAC CE associated with the PDU, the UE 101 may further generate a head/end indication 101B for indicating head/end of the UL PDU set. The head indication 101B may be used to indicate the head of a PDU set. The end indication 101B may be used to indicate the end of a PDU set. Then, the UE 101 may transmit the head/end indication 101B to the BS 102. If the “FI” field is present in the PDPC header, the receiving PDCP entity can further differentiate a PDU set boundary based on the “FI” field value and the head/end indicator after the PDCP reordering operation.

In some embodiments, the end indication 101B may be included in a layer 2 header of the last PDU of the UL PDU set, the start indication 101B may be included in a layer 2 header of the start PDU of the UL PDU set.

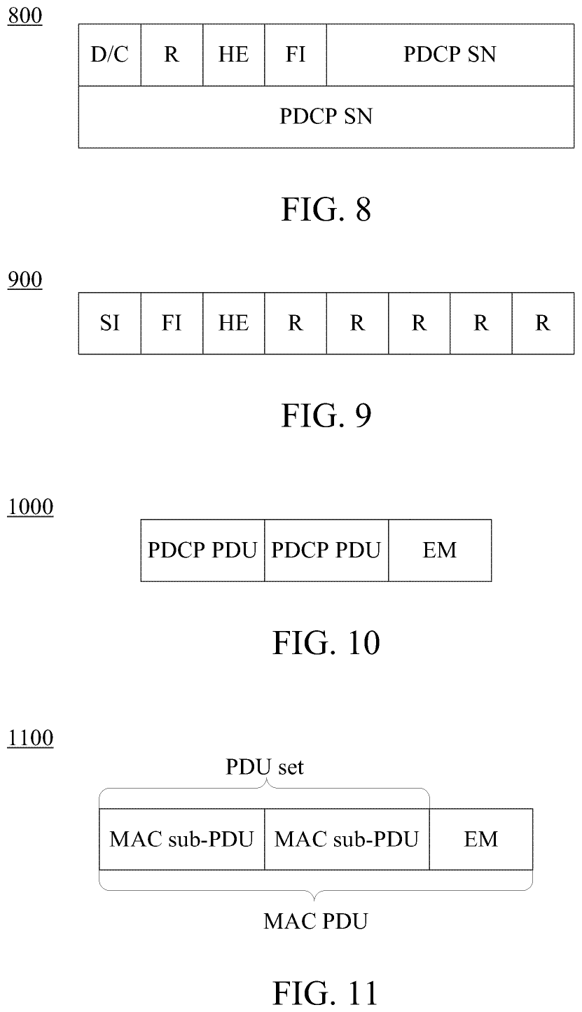

In some cases, the layer 2 header of the last PDU or the start PDU may be a PDCP header. Specifically, refer to FIG. 8 which is a schematic diagram of the PDCP header 800 in accordance with some embodiments of the present application, the PDCP header 800 may include at least one field of: (1) “D/C”; (2) “HE”; (3) “FI”; and (4) “PDCP SN”. In detail, “D/C” field may indicate type of data PDU or control PDU. “HE” field may be the head/end indication 101B. “FI” field may be the indication 101A. “PDCP SN” field may be the sequence of the corresponding PDCP.

In some cases, the layer 2 header of the last PDU or the start PDU may be an RLC header. Specifically, refer to FIG. 9 which is a schematic diagram of the RLC header 900 in accordance with some embodiments of the present application, the RLC header 900 may include at least one field of: (1) “SI”; (2) “FI”; (3) “HE”; and (4) “R”. In detail, “SI” field may indicate whether an RLC PDU contains a complete RLC SDU or the first, middle, last segment of an RLC SDU. “FI” field may be the indication 101A. “HE” field may be the indication 101B. “R” field may be reserved bit(s). For example, “HE” field may be 1 bit. For example, Value 0 may indicate an associated PDCP SDU is the first PDU of the PDU set. For example, Value 1 may indicate the associated PDCP SDU is the last PDU of the PDU set. For example, “HE” field is only placed at the RLC header of the complete RLC SDU.

In some embodiments, the end indication 101B may be included in a layer 2 control element followed a last PDU of the PDU set.

In some cases, the layer 2 control element may be a PDCP control PDU. Specifically, refer to FIG. 10 which is a schematic diagram of using a PDCP control PDU in accordance with some embodiments of the present application, the PDCP layer of the UE 101 may generate a PDCP control PDU 1000 with an end mark EM at the end of PDCP SDU(s) corresponding to the PDU set. Then, the UE 101 may send the PDCP control PDU 1000 to lower layer at the end of the PDU set. It should be noted that a new PDCP type may be introduced to identify the PDCP Control PDU 1000 with end mark.

In some cases, the layer 2 control element may be a MAC CE. Specifically, refer to FIG. 11 which is a schematic diagram of using a MAC CE in accordance with some embodiments of the present application, the MAC layer of the UE 101 may generate a MAC CE 1100 with an end mark at the end of the MAC sub-PDUs including the MAC SDUs corresponding to the PDU set in a MAC PDU. A new logical channel ID may be used to indicate the type of the MAC CE 1100 with the end mark. The MAC layer of the UE 101 may multiplex the MAC CE 1100 with the end mark followed the end of the MAC sub-PDUs including the MAC SDUs corresponding to the PDU set. It should be noted that the MAC CE 1100 with the end mark may be generated based on reception of a PDCP indication or be generated periodically.

If the MAC CE has higher priority than the LCH of the MAC SDUs, and there's not enough grant for both the last MAC SDU of one PDU set and the MAC CE with the end mark, the MAC CE with end mark will not be multiplexed in this MAC PDU. One possibility is to cancel the MAC CE with the end mark in this case.

In some embodiments, the indication 101A is included in the MAC CE associated with the PDU (i.e., MAC PDU). In particular, when the UE 101 multiplexes MAC SDUs corresponding to the PDU set, the UE 101 may determine the indication 101A to indicate a corresponding MAC SDUs, which may come from different PDU set, of the MAC PDU.

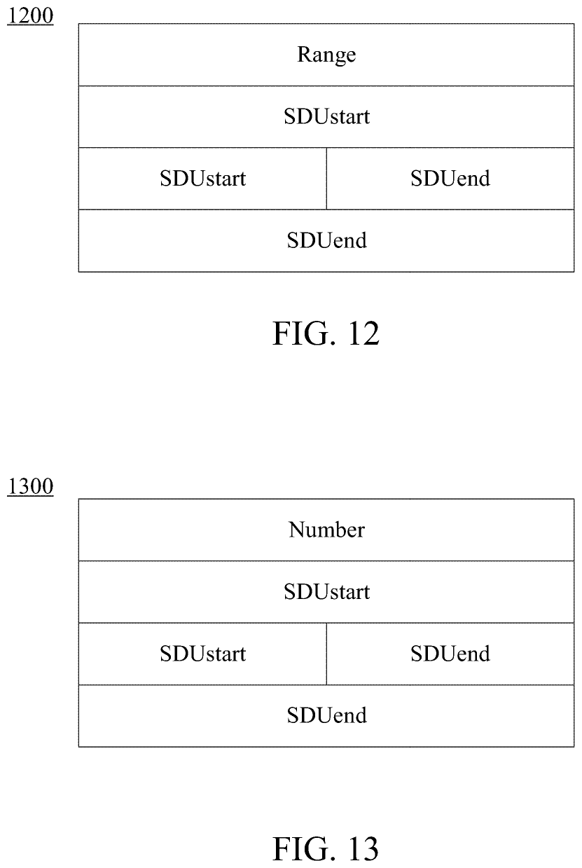

In some cases, refer to FIG. 12 which is a schematic diagram of the indication 101A included in a MAC CE 1200 in accordance with some embodiments of the present application, the indication 101A of the MAC CE 1200 may include one field of: (1) “Range”; (2) “SDUstart”; and (3) “SDUend”. In detail, “Range” field may be a number of PDU set(s) in the corresponding MAC PDU. “SDUstart” field may indicate a start position of MAC SDU(s) belonging to the same PDU set. For example, “SDUstart” indicates an offset in byte from the left side of the corresponding MAC PDU, or indicates an offset in the number of the SDU(s) from the left side of the corresponding MAC PDU. “SDUend” field may indicate an end potion of the MAC SDU(s) belonging to the same PDU set. For example, “SDUend” field indicates an offset in byte from the left side of the corresponding MAC PDU, or indicates an offset in the number of the SDU(s) from the left side of the MAC PDU.

It should be noted that, when there is available MAC SDU corresponding to one LCH to be multiplexed onto a transport block and the LCH is configured to trigger the MAC CE 1200 including the indication 101A by the BS 102, the MAC CE 1200 including the indication 101A may be triggered. When all MAC SDUs corresponding to one LCH only belong to one PDU set, the MAC CE 1200 including the indication 101A may be cancelled.

In some cases, refer to FIG. 13 which is a schematic diagram of the indication 101A included in a MAC CE 1300 in accordance with some embodiments of the present application, the indication 101A may include at least one field of: (1) “Number”; (2) “SDUstart”; and (3) “SDUend”. In detail, “Number” field may indicate PDU set number (i.e., PDU set index) in the corresponding MAC PDU. “SDUstart” field may indicate a start position of MAC SDU(s) belonging to the same PDU set. For example, “SDUstart” indicates an offset in byte from the left side of the corresponding MAC PDU, or indicates an offset in the number of the SDU(s) from the left side of the corresponding MAC PDU. “SDUend” field may indicate an end potion of the MAC SDU(s) belonging to the same PDU set. For example, “SDUend” field indicates an offset in byte from the left side of the corresponding MAC PDU, or indicates an offset in the number of the SDU(s) from the left side of the MAC PDU.

It should be noted that, in the above embodiments, the indications are demonstrated for UL transmission (i.e., from the UE 101 to the BS 102). In some embodiments, the indications having the same mechanisms may also be applied to DL transmission (i.e., from the BS 102 to the UE 101) to assist the UE 101 determine whether the PDU set is successfully received. More specifically, the BS 102 may determine a PDU belonging to a DL PDU set arrives from the GTP tunnel. Then, the BS 102 may determine an indication (not shown) of the PDU belonging to the DL PDU set and transmit the indication in the layer 2 header of the PDU or in the MAC CE to the UE 101.

In some embodiments, the indication 101A is included in a layer 2 header of a BSR MAC CE. In particular, when the UE 101 determines that a new PDU set or another PDU set arrives from an upper layer of the UE 101, the UE 101 determines the indication 101A and includes the indication 101A in a MAC sub-header of the BSR MAC CE. The indication 101A is used to indicate the arrival of the new PSU set or another PDU set.

In some embodiments, the BSR MAC CE may indicate at least one original PDU set size or at least one PDU set buffer size. The indication 101A may be further included in a layer 2 header of a BSR MAC CE.

In some embodiments, a function of the indication 101A of the layer 2 header may be enabled per logical channel (LCH), per logical channel group (LCG), per data radio bearer (DRB) or per QoS flow identifier (QFI) by the BS 102. When a specific LCG is configured to enable the function of the indication 101A by the BS 102, the UE 101 set the toggled value of the indication 101A of the layer 2 header corresponding to buffer size of the specific LCG.

In some embodiments, the indication 101A is a BSR MAC CE. In particular, when the UE 101 determines that a new PDU set or another PDU set arrives from an upper layer of the UE 101, the UE 101 determines a BSR MAC CE, which has different format from legacy BSR MAC CE, as the indication 101A. The BSR MAC CE as the indication 101A is used to indicate the arrival of the new PDU set or another PDU set. The BSR MAC CE may further indicate at least one original PDU set size or at least one PDU set buffer size, can be called a new type of MAC CE, e.g., PDU SET SIZE MAC CE.

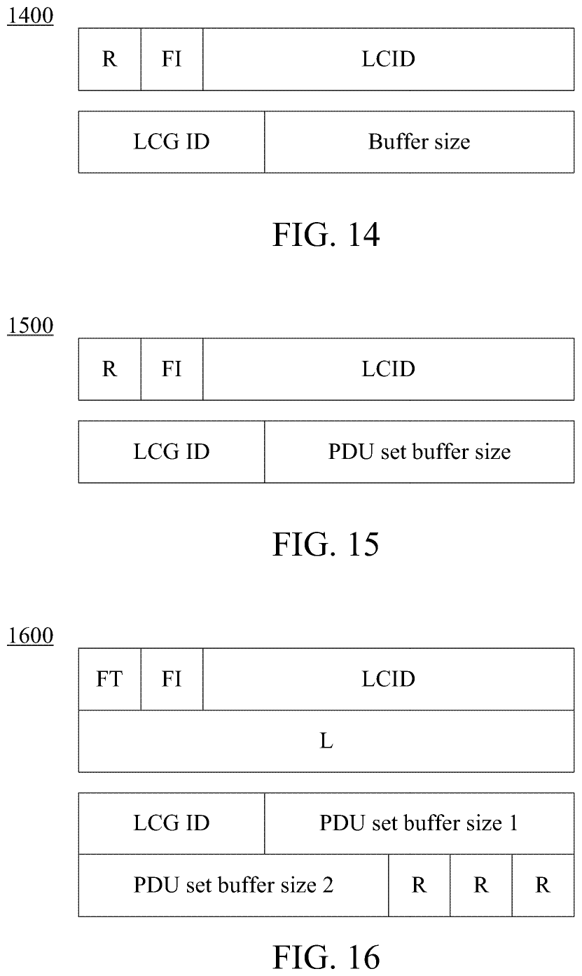

In some cases, refer to FIG. 14 which is a schematic diagram of a BSR MAC CE 1400 in accordance with some embodiments of the present application, the BSR MAC CE 1400 may include fields of: (1) “R”; (2) “FI”; (3) “LCID”; (4) “LCG ID”; and (5) “Buffer size”. In detail, “R” field may be reserved bit(s). “FI” field may be the indication 101A. “LCID” field may indicate the type of the MAC CE. “LCG ID” field may indicate logical channel group identification. “Buffer size” field may identify the total amount of data available according across all logical channels of a logical channel group after the generation of the corresponding MAC PDU.

In some cases, refer to FIG. 15 which is a schematic diagram of a BSR MAC CE 1500 in accordance with some embodiments of the present application, the BSR MAC CE 1500 may include fields of: (1) “R”; (2) “FI”; (3) “LCID”; (4) “LCG ID”; and (5) “PDU set Buffer size” and can be called a new MAC CE, e.g., PDU SET SIZE MAC CE. In detail, “R” field may be reserved bit(s). “FI” field may be the indication 101A. “LCID” field may indicate the type of the corresponding MAC CE. “LCG ID” field may indicate logical channel group identification. “PDU set Buffer size” field may identify the total amount of data available of the new arrival PDU set(s) according across all logical channels of a logical channel group after the generation of the corresponding MAC PDU. In these cases, none of the data has not been multiplexed to a TB for transmission for the new arrival PDU set(s).

The BSR MAC CE 1500 may be triggered when new PDU set arrives from the upper layer of the UE 101. The BSR MAC CE 1500 may be cancelled when the BSR MAC CE 1500 including the PDU set buffer size of the new PDU set(s) arriving from the upper layer of the UE 101 has been multiplexed to a MAC PDU.

In some cases, refer to FIG. 16 which is a schematic diagram of a BSR MAC CE 1600 in accordance with some embodiments of the present application, the UE 101 may report the BSR per PDU set and the BSR MAC CE 1600 may include at least one field of: (1) “FT”; (2) “FI”; (3) “LCID”; (4) “L”; (5) “LCG ID”; (6) “PDU buffer size”; and (7) “R” and can be called a new MAC CE, e.g., PDU SET SIZE MAC CE. In detail, “FT” field may indicate a type of the PDU set buffer size for one LCG (e.g., 5 bits PDU set based BSR or 8 bits PDU set based BSR). “FI” field may be the indication 101A. “LCID” field may indicate the type of the corresponding MAC CE. “LCG ID” field may indicate logical channel group identification. “L” filed may indicate length of corresponding MAC SDU or variable-sized MAC CE. “PDU set Buffer size” and “PDU set Buffer size” fields may identify the total amount of data available for each PDU set according across all logical channels of a logical channel group after the generation of the corresponding MAC PDU. “R” field may be reserved bit(s). The BSR MAC CE may be triggered when new PDU set arrives from the upper layer of the UE 101. The BSR MAC CE 1600 may be cancelled when the BSR MAC CE 1600 including the PDU set buffer size of the new PDU set(s) arriving from the upper layer of the UE 101 has been multiplexed to a MAC PDU.

It should be noted that, when there is available data involving more than one PDU set, there will be more than one “PDU set Buffer Size” fields in the BSR MAC CE 1600. The MAC entity of the UE 101 may report the buffer size of the available data for each PDU set following an increasing order of PDU set arrival time at the UE 101 side. For example, “PDU set buffer size 1” indicates the available data for one PDU set. Part data of this PDU set has been multiplexed to a TB for transmission or has been transmitted to the BS 102. “PDU set buffer size 2” indicates the available data for a subsequent PDU set and none of the data of the subsequent PDU set has not been multiplexed to a TB for transmission. In some situations, the PDU set buffer size(s), which indicates available data and none of the data has been multiplexed to a TB for transmission, is (are) reported. In some situations, the PDU set buffer size(s), which indicates available data and part of the data has been transmitted to the BS 102, is (are) ignore.

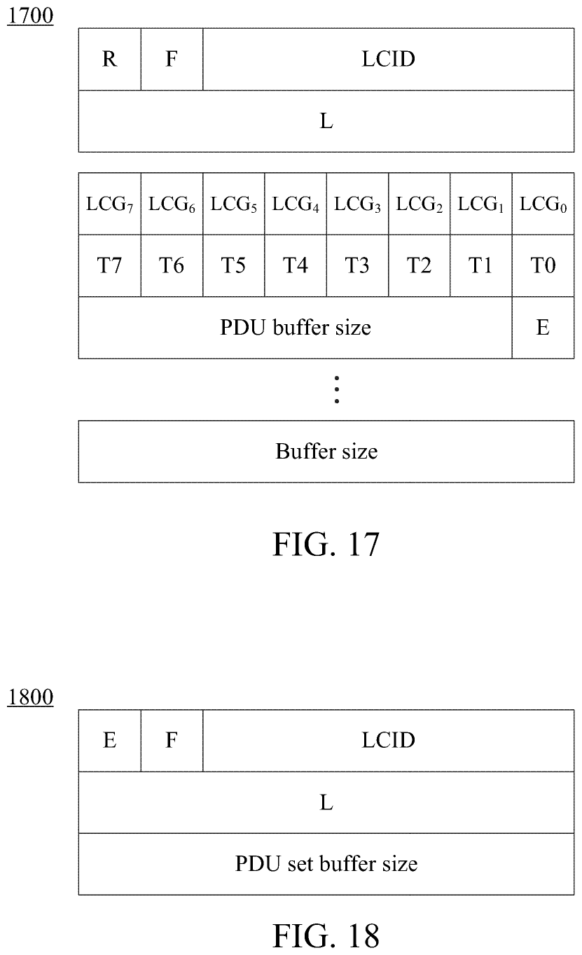

In some cases, refer to FIG. 17 which is a schematic diagram of a BSR MAC CE 1700 in accordance with some embodiments of the present application, the UE 101 may report the BSR per PDU set and the BSR MAC CE 1700 may include at least one field of: (1) “R”; (2) “F”; (3) “LCID”; (4) “L”; (5) “LCGᵢ”; (6) “Ti”; (7) “PDU set buffer size”; (8) “E”; and “Buffer size” and can be called a new MAC CE, e.g., PDU SET SIZE MAC CE. In detail, “R” field may be reserved bit(s). “F” field may be a value indicating the size of “L” field. “LCID” field may indicate the type of the corresponding MAC CE. “LCGi” field may indicate the presence of corresponding “Buffer size” field for the logical channel group i. For example, “LCGᵢ” field set to 1 indicates that the corresponding “Buffer size” field for LCG i is reported, and the “LCGᵢ” field set to 0 indicates that the corresponding “Buffer size” field for LCG i is not reported. “Ti” field may indicates the presence of corresponding “PDU set buffer size” or legacy “Buffer size” for LCG i. For example, “Ti” field set to 1 indicates that “PDU set buffer size” field and corresponding “E” field are followed. “Ti” field set to 0 indicates that “Buffer size” is followed.

“PDU set Buffer size” field(s) may identify the total amount of data available for each PDU set according across all logical channels of a logical channel group after the generation of the corresponding MAC PDU. “E” field may indicate whether “PDU set buffer size” of another PDU set is followed. For example, “E” field may indicate whether “PDU set buffer size” and corresponding “E” field follow “E” field. For example, “E” field set to 1 indicates that “PDU set buffer size” field and corresponding “E” field follow “E” field. “E” field set to 0 indicates that “PDU set buffer size” field and corresponding “E” field do not follow “E” field. “Buffer size” field may identify the total amount of data available according across all logical channels of a logical channel group after the generation of the corresponding MAC PDU.

In some embodiments, that “PDU set buffer size” field can be included in the MAC sub-header. In some cases, refer to FIG. 18 which is a schematic diagram of a MAC sub-header 1800 in accordance with some embodiments of the present application, the UE 101 may report the BSR per PDU set and the MAC sub-header 1800 may include at least one field of: (1) “E”; (2) “F”; (3) “LCID”; (4) “L”; and (5) “PDU set buffer size”. In detail, “E” field may indicate whether “PDU set buffer size” field follows “L” field. For example, “E” field set to 1 indicates that “PDU set buffer size” field follows “L” field. “E” field set to 0 indicates that “PDU set buffer size” field does not follow “L” field. “F” field may indicates the size of “L” field. “L” filed may indicate length of corresponding MAC SDU or variable-sized MAC CE. “LCID” field may indicate logical channel identification of the corresponding MAC SDU. “PDU set Buffer size” field(s) may identify the total amount of data available for one PDU set associated with the LCID after the generation of the corresponding MAC PDU. In some situations, this MAC sub-header is used only for the first MAC SDU of the PDU set in the MAC PDU.

In some embodiments, that “PDU set buffer size” field may be included in the PDCD header. The PDCP header may include at least one field of: (1) “D/C”; (2) “E”; (3) “R”; and (4) “PDCP SN and 5) “PDU set buffer size”. In detail, “D/C” field may indicate type of data PDU or control PDU. “R” field may be reserved bit(s). “E” field may indicate whether “PDU set buffer size” field follows “PDCP SN” field. “PDCP SN” field may be the sequence of the corresponding PDCP. “PDU set Buffer size” field(s) may identify the total amount of data available for one PDU set associated with the DRB. In some situations, this type of the MAC sub-header is used only for the first PDCP SDU of the PDU set.

In some embodiments, “PDU set buffer size” field of the above embodiments may be replaced by “Original PDU set size” field. “Original PDU set size” field may indicates the data volume of the available PDCP SDU(s) corresponding to one PDU set received from the upper layer of the UE 101. Original PDU set size may be obtained from another indication from the upper layer of the UE 101.

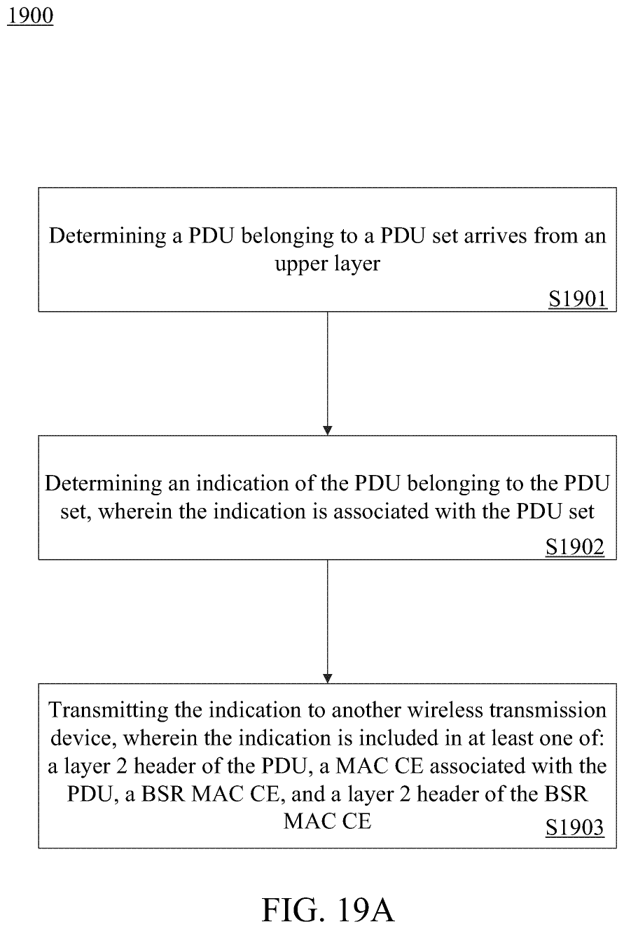

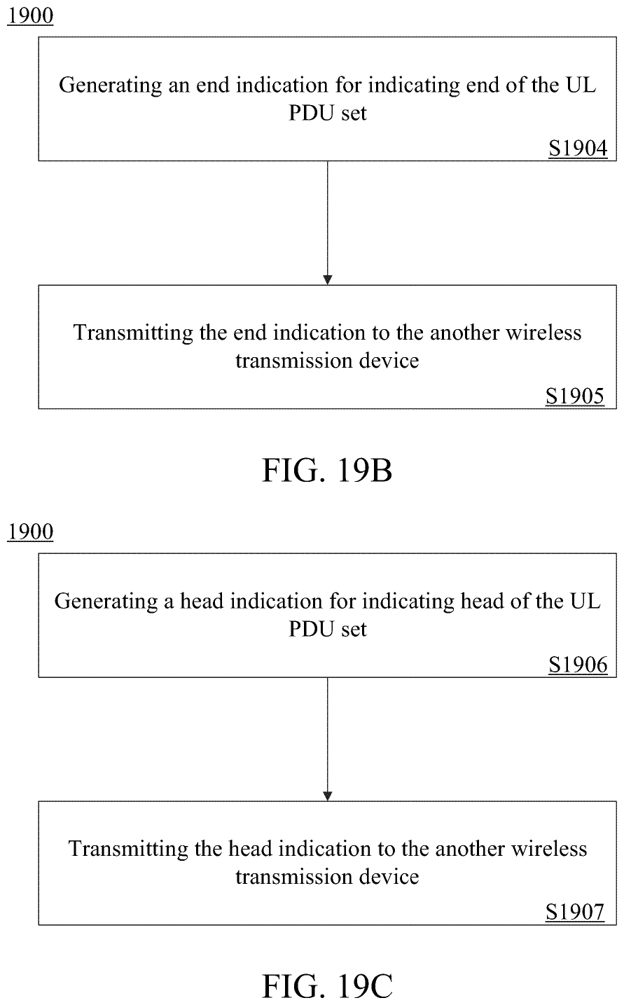

FIGS. 19A to 19C illustrate flow charts of a method for wireless communications in accordance with some embodiments of the present application. Referring to FIGS. 19A to 19C, method 1900 is performed by a wireless transmission device (e.g., a UE or a BS) in some embodiments of the present application.

In some embodiments, operation S1901 is executed to determine, by the wireless transmission device, a PDU belonging to a PDU set to be transmitted (i.e., the PDU arrives from an upper layer). Operation S1902 is executed to determine, by the wireless transmission device, an indication of the PDU belonging to the PDU set. The indication may be associated with the PDU set. Operation S1903 is executed to transmit, by the wireless transmission device, the indication to another wireless transmission device. The indication may be included in at least one of: (1) a layer 2 header of the PDU; (2) a MAC CE associated with the PDU; (3) a layer 2 header of a BSR MAC CE; (4) a BSR MAC CE.

In some embodiments, the PDU set may include a video frame or an ADU or a video slice. In some embodiments, the indication may be included in the layer 2 header of the PDU, and the indication includes a toggled value. In some embodiments, the layer 2 header of the PDU is a MAC sub-header, an RLC header, a PDCP header or an SDAP header. In some embodiments, a function of the indication may be enabled per LCH, per LCG, per DRB, or per QFI by the another wireless transmission device.

In some embodiments, when the indication is included in the layer 2 header of the PDU or the MAC CE associate with the PDU, operation S1904 is executed to generate, by the wireless transmission device, an end indication for indicating end of the PDU set. Operation S1905 is executed to transmit, by the wireless transmission device, the end indication to the another wireless transmission device. The end indication may be included in a layer 2 control element followed a last PDU of the PDU set.

In some embodiments, the layer 2 control element followed the last PDU may include a PDCP control PDU or a MAC CE. In some embodiments, both the end indication and a toggled value may be in a PDCP header or an RLC header.

In some embodiments, when the indication is included in the layer 2 header of the PDU or the MAC CE of the PDU, operation S1906 is executed to generate, by the wireless transmission device, a head indication for indicating head of the PDU set. Operation S1907 is executed to transmit, by the wireless transmission device, the head indication to the another wireless transmission device. The head indication may be included in a layer 2 header of a first PDU of the PDU set.

In some embodiments, when the indication is included in the MAC CE of the PDU and the indication indicates an association of at least one SDU of the PDU, the indication may include: (1) a number of PDU set and an end SDU indication associated with the PDU set in a MAC PDU; or (2) an index of PDU set and an end SDU indication associated with the PDU set in the MAC PDU. In some embodiments, the indication may further include a start SDU indication associated with the PDU set.

In some embodiments, the indication may be included in a layer 2 header of the BSR MAC CE. In some embodiments, the indication may further indicate at least one original PDU set size or at least one PDU set buffer size. In some embodiments, the indication may include a toggled value of the UL PDU set. In some embodiments, a function of the indication may be enabled per LCH, per LCG, per DRB, or per QFI by the another wireless transmission device.

In some embodiments, the indication may be a BSR MAC CE. In some embodiments, the BSR MAC CE may include a PDU set buffer size or an original PDU set size for one LCG. In some embodiments, the BSR MAC CE may include a field for indicating a size of the PDU set buffer size or indicating the size of the original PDU set size is present. In some embodiments, the BSR MAC CE may include a plurality of PDU set buffer sizes or a plurality of original PDU set buffer sizes for a plurality of LCGs. In some embodiments, a MAC sub-header corresponding to a MAC SDU may include a PDU set buffer size or an original PDU set size.

In some embodiments, the indications may be utilized for UL transmission (i.e., from the UE to the BS). In some embodiments, the indications may be utilized for DL transmission (i.e., from the BS to the UE).

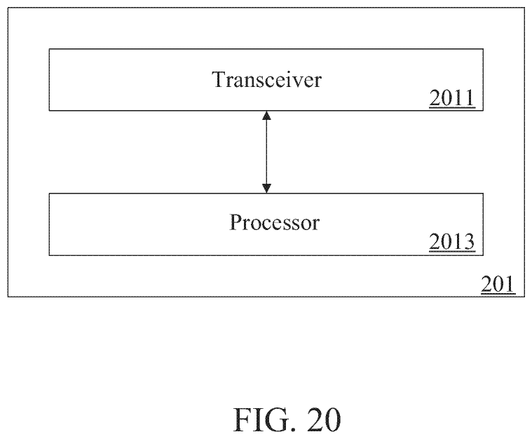

FIG. 20 illustrates an example block diagram of a wireless transmission device 201 according to an embodiment of the present disclosure.

As shown in FIG. 20, the wireless transmission device 201 may include at least one non-transitory computer-readable medium (not illustrated in FIG. 20), a transceiver 2011 and a processor 2013 electrically coupled to the non-transitory computer-readable medium (not illustrated in FIG. 20) and the transceiver 2011. The wireless transmission device 201 may be a UE or a BS.

Although in this figure, elements such as processor 2013 and transceiver 2011 are described in the singular, the plural is contemplated unless limitation to the singular is explicitly stated. In some embodiments of the present disclosure, the transceiver 2011 may be separated into to circuitry, such as a receiving circuitry and a transmitting circuitry. In certain embodiments of the present disclosure, the wireless transmission device 201 may further include an input device, a memory, and/or other components.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 2013 interacting with the transceiver 2011, so as to perform the operations with respect to the UE depicted in the figures.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A wireless transmission device, comprising:
at least one memory; and
at least one processor coupled with the at least one memory and configured to cause the wireless transmission device to:
determine an indication of a protocol data unit (PDU) belonging to a PDU set to be transmitted, wherein the indication is associated with the PDU set;
transmit the indication to another wireless transmission device, wherein the indication is included in at least one of:
a layer 2 header of the PDU,
a media access control (MAC) control element (CE) associated with the PDU,
a buffer status report (BSR) MAC CE, and
a layer 2 header of the BSR MAC CE.

2. The wireless transmission device of claim 1, wherein the at least one processor is configured to cause the wireless transmission device to:
determine the PDU belonging to the PDU set arrives from an upper layer.

3. The wireless transmission device of claim 1, wherein the PDU set includes a frame or an application data unit (ADU).

4. The wireless transmission device of claim 1, wherein the indication is included in the layer 2 header of the PDU, and the indication includes at least one toggled value.

5. The wireless transmission device of claim 4, wherein the layer 2 header of the PDU is a MAC sub-header, a radio link control (RLC) header, a packet data convergence protocol (PDCP) header or a service data adaptation protocol (SDAP) header.

6. The wireless transmission device of claim 4, wherein a function of the indication is enabled per logical channel (LCH), per logical channel group (LCG), per data radio bearer (DRB), or per QoS flow identifier (QFI) by the another wireless transmission device.

7. The wireless transmission device of claim 1, wherein the indication is included in the layer 2 header of the PDU or the MAC CE associated with the PDU, and the at least one processor is configured to cause the wireless transmission device to:
generate an end indication for indicating end of the PDU set; and
transmit the end indication to the another wireless transmission device, wherein the end indication is included in a layer 2 control element followed a last PDU of the PDU set or included in a layer 2 header of the last PDU of the PDU set.

8. The wireless transmission device of claim 7, wherein the layer 2 control element followed the last PDU includes a packet data convergence protocol (PDCP) control protocol data unit (PDU) or a MAC CE.

9. The wireless transmission device of claim 7, wherein the end indication includes a toggled value in a packet data convergence protocol (PDCP) header or a radio link control (RLC) header.

10. The wireless transmission device of claim 1, wherein the indication is included in the layer 2 header of the PDU or the MAC CE of the PDU, and the at least one processor is configured to cause the wireless transmission device to:
generate a head indication for indicating head of the PDU set; and
transmit the head indication to the another wireless transmission device, wherein the head indication is included in a layer 2 header of a first PDU of the PDU set.

11. The wireless transmission device of claim 1, wherein the indication is included in the MAC CE of the PDU, and the indication indicates an association of at least one service data unit (SDU) of the PDU.

12. The wireless transmission device of claim 11, wherein the indication includes:
a number of PDU set and an end SDU indication associated with the PDU set in a MAC PDU; or
an index of PDU set and an end SDU indication associated with the PDU set in the MAC PDU.

13. The wireless transmission device of claim 12, wherein the indication further includes a start SDU indication associated with the PDU set.

14. The wireless transmission device of claim 1, wherein the BSR MAC CE further includes at least one original PDU set size or at least one PDU set buffer size.

15. The wireless transmission device of claim 14, wherein the indication in the layer 2 header of the BSR MAC CE includes a toggled value of the PDU set.

16. The wireless transmission device of claim 15, wherein a function of the indication is enabled per logical channel (LCH), per logical channel group (LCG), per data radio bearer (DRB), or per QoS flow identifier (QFI) by the another wireless transmission device.

17. (canceled)

18. (canceled)

19. (canceled)

20. (canceled)

21. (canceled)

22. A method of a wireless transmission device, comprising:
determining, by the wireless transmission device, an indication of a protocol data unit (PDU) belonging to a PDU set to be transmitted, wherein the indication is associated with the PDU set;
transmitting, by the wireless transmitting device, the indication to another wireless transmission device, wherein the indication is included in at least one of:
a layer 2 header of the PDU,
a media access control (MAC) control element (CE) associated with the PDU,
a buffer status report (BSR) MAC CE, and
a layer 2 header of the BSR MAC CE.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A wireless transmission device, comprising:
at least one memory; and
at least one processor coupled with the at least one memory and configured to cause the wireless transmission device to:
receive an indication of a protocol data unit (PDU) belonging to a PDU set from another wireless transmission device, wherein the indication is associated with the PDU set, and is included in at least one of:
a layer 2 header of the PDU,
a media access control (MAC) control element (CE) associated with the PDU,
a buffer status report (BSR) MAC CE, and
a layer 2 header of the BSR MAC CE.

44. The wireless transmission device of claim 43, wherein the at least one processor is configured to cause the wireless transmission device to:
transmit a configuration to the another wireless transmission device to enable a function of the indication per logical channel (LCH), per data radio bearer (DRB), per logical channel group (LCG), or per QoS flow identifier (QFI).

45. A method performed by a wireless transmission device, the method comprising:
receiving an indication of a protocol data unit (PDU) belonging to a PDU set from another wireless transmission device, wherein the indication is associated with the PDU set, and is included in at least one of:
a layer 2 header of the PDU,
a media access control (MAC) control element (CE) associated with the PDU,
a buffer status report (BSR) MAC CE, and
a layer 2 header of the BSR MAC CE.
